(19) United States
(12) Patent Application Publication
(10) Pub. No.: US 2014/0212694 A1
(43) Pub. Date: Jul. 31, 2014

(54) COMPOSITE ANODE ACTIVE MATERIAL, ANODE INCLUDING THE SAME, LITHIUM BATTERY INCLUDING THE ANODE, AND METHOD OF PREPARING THE COMPOSITE ANODE ACTIVE MATERIAL

(71) Applicant: SAMSUNG SDI CO., LTD., Yongin-si (KR)

(72) Inventors: Yo-Han PARK, Yongin-si (KR); Young-Ugk KIM, Yongin-si (KR); Seung-Uk KWON, Yongin-si (KR); Jae-Hyuk KIM, Yongin-si (KR); Soon-Sung SUH, Yongin-si (KR); Yury MATULEVICH, Yongin-si (KR); Duk-Hyoung YOON, Yongin-si (KR); Hee-Young CHU, Yongin-si (KR); Chang-Ui JEONG, Yongin-si (KR)

(73) Assignee: SAMSUNG SDI CO., LTD., Yongin-si (KR)

(21) Appl. No.: 14/106,981

(22) Filed: Dec. 16, 2013

(30) Foreign Application Priority Data
Jan. 29, 2013 (KR) 10-2013-0010095

(51) Int. Cl. H01M 4/36; H01M 4/38

(52) U.S. Cl. CPC H01M 4/366; H01M 4/386; H01M 4/387
USPC 429/5; 429/231.8; 429/231.5; 429/224; 429/221; 429/223; 429/220; 429/229; 429/231.6; 429/226; 429/219; 429/222; 252/182.1

(57) ABSTRACT

A composite anode active material, an anode including the composite anode active material, a lithium battery including the anode, and a method of preparing the composite anode active material, the composite anode active material including a core including a ternary alloy, the ternary alloy being capable of intercalating and deintercalating lithium; and a carbonaceous coating layer on the core.

### CROSS-REFERENCE TO RELATED APPLICATION

Korean Patent Application No. 10-2013-0010095, filed on Jan. 29, 2013, in the Korean Intellectual Property Office, and entitled: “Composite Anode Active Material, Anode Including the Same, Lithium Battery Including the Anode, and Method of Preparing the Composite Anode Active Material,” is incorporated by reference herein in its entirety.

### BACKGROUND

1. Field

Embodiments relate to a composite anode active material, an anode including the composite anode active material, a lithium battery including the anode, and a method of preparing the composite anode active material.

2. Description of the Related Art

Lithium batteries have high voltage and high energy density, and thus may be used in various applications. Devices such as electric vehicles (HEV, PHEV), and the like may be operable at high temperatures, may be able to charge or discharge a large amount of electricity, and may have long-term usability. Thus, such devices may require lithium batteries having high-discharge capacity and better lifetime characteristics.

### SUMMARY

Embodiments are directed to a composite anode active material, an anode including the composite anode active material, a lithium battery including the anode, and a method of preparing the composite anode active material.

The embodiments may be realized by providing a composite anode active material including a core including a ternary alloy, the ternary alloy being capable of intercalating and deintercalating lithium; and a carbonaceous coating layer on the core.

The ternary alloy may include a matrix inert to lithium; and a crystalline phase dispersed in the matrix, the crystalline phase being capable of intercalating and deintercalating lithium.

The crystalline phase may include at least one element selected from the elements of Group 14 of the periodic table of the elements.

The crystalline phase may include at least one element selected from the group of silicon, germanium, and tin.

The crystalline phase may include silicon.

The crystalline phase may include nano-sized crystallite.

The crystallite may have a size of about 33.5 nm or less.

The crystallite may have a size of about 30 nm to about 33 nm.

The crystalline phase may exhibit a peak with a full width at half maximum (FWHM) of about 0.245° or greater at a diffraction angle (2θ) of 28.50°±0.10° in X-ray diffraction spectra.

The FWHM may be in a range of 0.245°≦FWHM≦0.265°.

The matrix may include one element selected from the elements of Group 14 of the periodic table of the elements, and two elements selected from transition metals of Group 3 to Group 12 of the periodic table of the elements.

The ternary alloy may have a composition represented by Formula 1 below:

M1ₐM2_{b}M3_{c} <Formula 1>

wherein, in Formula 1, 5<a<10, 1<b<5, and 1<c<5, M1 is silicon, germanium, or tin, and M2 and M3 are each independently an element selected from the group of scandium, titanium, vanadium, chromium, manganese, iron, cobalt, nickel, copper, zinc, magnesium, calcium, strontium, barium, radium, yttrium, zirconium, hafnium, rutherfordium, niobium, tantalum, dubnium, molybdenum, tungsten, seaborgium, technetium, rhenium, bohrium, iron, lead, ruthenum, osmium, hassium, rhodium, iridium, platinum, silver, gold, cadmium, boron, aluminum, gallium, tin, indium, germanium, phosphorus, arsenic, antimony, bismuth, sulfur, selenium, tellurium, and polonium.

The carbonaceous coating layer may include amorphous carbon.

The core may have a D50 average particle diameter of about 1 μm to about 10 μm.

The embodiments may also be realized by providing an anode comprising the composite anode active material according to an embodiment.

The embodiments may also be realized by providing a lithium battery comprising the anode according to an embodiment.

The embodiments may also be realized by providing a method of preparing a composite anode active material, the method including preparing a solution that includes a ternary alloy and a carbon precursor; drying the solution to obtain a dried product; and calcining the dried product.

The calcining may be performed at a temperature of less than about 600° C.

The calcining may be performed under an inert atmosphere.

The carbon precursor may include a nonionic surfactant.

The carbon precursor may include at least one selected from the group of polyoxyethylene glycol alkyl ethers, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, dodecyldimethylamine oxide, ethanol amide, block copolymers of polyethylene glycol and polypropylene glycol, and polyethoxylated tallow amine.

The ternary alloy may have an average particle diameter from about 1 μm to about 10 μm.

The ternary alloy may have a composition represented by Formula 1 below:

M1ₐM2_{b}M3_{c} <Formula 1>

wherein, in Formula 1, 5<a<10, 1<b<5, and 1<c<5, M1 is silicon, germanium, or tin, and M2 and M3 are each independently an element selected from the group of scandium, titanium, vanadium, chromium, manganese, iron, cobalt, nickel, copper, zinc, magnesium, calcium, strontium, barium, radium, yttrium, zirconium, hafnium, rutherfordium, niobium, tantalum, dubnium, molybdenum, tungsten, seaborgium, technetium, rhenium, bohrium, iron, lead, ruthenum, osmium, hassium, rhodium, iridium, platinum, silver, gold, cadmium, boron, aluminum, gallium, tin, indium, germanium, phosphorus, arsenic, antimony, bismuth, sulfur, selenium, tellurium, and polonium.

### BRIEF DESCRIPTION OF THE DRAWINGS

Features will become apparent to those of skill in the art by describing in detail exemplary embodiments with reference to the attached drawings in which:

FIG. 1 illustrates a scanning electron microscopic (SEM) image of ternary alloy powder of Si₇Ti₄Ni₄ prepared in Example 1;

FIG. 2 illustrates a graph showing discharge capacity with respect to number of cycles in lithium batteries of Example 3 and Comparative Example 2;

FIG. 3 illustrates a graph showing discharge capacity with respect to number of cycles in lithium batteries of Reference Examples 3 and 4;

FIG. 4 illustrates a graph showing lifetime characteristics (a graph of capacity retention with respect to number of cycles) in lithium batteries of Example 3 and Comparative Example 2;

FIG. 5 illustrates a graph showing lifetime characteristics (a graph of capacity retention rate respect to number of cycles) in lithium batteries of Reference Examples 3 and 4); and

FIG. 6 illustrates a schematic view of a lithium battery according to an embodiment.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

Reference will now be made in detail to embodiment of a composite anode active material, an anode including the composite anode active material, a lithium battery using the anode, and a method of preparing the composite anode active material, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

According to an embodiment, a composite anode active material may include a core including a ternary alloy or mixture (capable of intercalating and deintercalating lithium); and a carbonaceous coating layer on the core.

Including the ternary alloy capable of intercalating and deintercalating lithium helps ensure that the composite anode active material reduces and/or prevents cracking caused by volumetric change during charging and discharging and that the composite anode active material may be less vulnerable to side reactions with an electrolyte solution. Thus, increased discharge capacity may be provided. The carbonaceous coating layer on the core including the ternary alloy may further suppress side reactions with electrolyte solution, and thus may facilitate reversible electrode reactions with improved conductivity.

In an implementation, the ternary alloy may be an alloy of, e.g., three elements. For example, the ternary alloy may include one element selected from among elements of Group 14 of the periodic table of the elements, and two elements selected from among the transition metals of Group 3 to Group 12 of the periodic table of the elements.

In an implementation, the ternary alloy in the composite anode active material may include a matrix that is inert to lithium, and a crystalline phase dispersed in the matrix, the crystalline phase being capable of intercalating and deintercalating lithium. The matrix that is inert to lithium may serve as a transfer path for lithium ions, and may not form an alloy with lithium. Rather, the crystalline phase may form an alloy with lithium (e.g., during operation of the battery). Being coated by the matrix that is inert to lithium, volumetric change and side reactions of the crystalline phase with the electrolyte solution (due to a disconnection with the electrolyte solution) may be suppressed. Thus, lifetime characteristics of a lithium secondary battery may be improved.

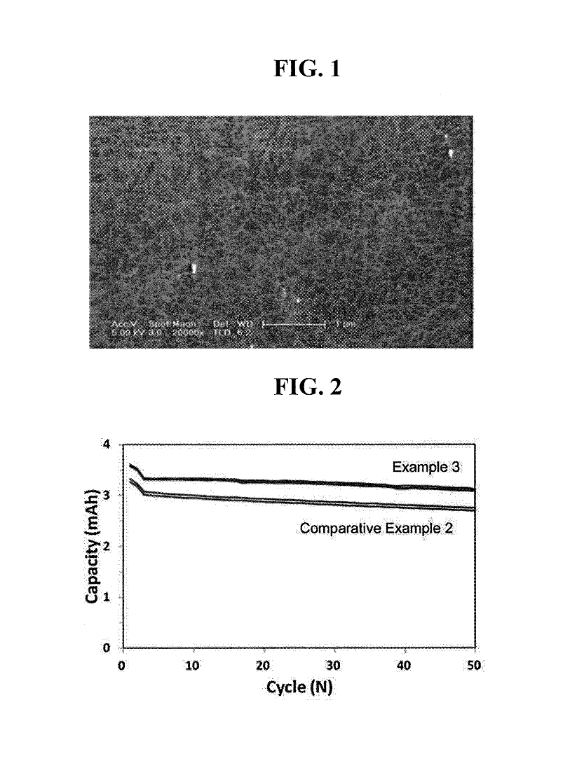

For example, as shown in FIG. 1, a ternary alloy of Si₇Ti₄Ni₄ according to an embodiment may include an inert matrix appearing as a dark region in FIG. 1, and a crystalline phase appearing as a bright region.

The crystalline phase of the ternary alloy may include one element selected from the elements of Group 14 of the periodic table of the elements. A crystalline phase having such a composition may help improve the discharge capacity of the composite anode active material. In an implementation, the crystalline phase may include one element selected from the group of Si, Ge, and Sn. For example, the crystalline phase may include Si.

The crystalline phase may include nano-sized crystallite. The nano-sized crystallite may help suppress volumetric change of the crystalline phase during charging and discharging. The crystalline phase may have a crystallite size of about 33.5 nm or less, e.g., from about 30 nm to about 33 nm or from about 31 nm to about 33 nm. When the size of crystallite of the crystalline phase is about 33.5 nm or less, the composite anode active material may have improved physical characteristics, compared with active materials including a crystalline phase having a larger crystallite size (e.g., as a result of thermal treatment at high temperatures of about 600° C. or higher).

The crystalline phase may exhibit a peak with a full width at half maximum (FWHM) of about 0.245° or greater at a diffraction angle (2θ) of 28.50°±0.10° in X-ray diffraction spectra. This peak may be from the [111] crystal plane of Si. For example, the peak of the crystalline phase may have a FWHM in the range of 0.245°≦FWHM≦0.265°. When the peak of the crystalline phase has a FWHM within these ranges, the composite anode active material may have improved discharge capacity and improved lifetime characteristics.

The matrix (that is inert to lithium) may include one element selected from the elements of Group 14 of the periodic table of the elements, and two elements selected from the transition metals of Group 3 to Group 12 of the periodic table of the elements. For example, the matrix may include all the elements of the ternary alloy. The matrix may form a ternary alloy of Group 14 element-Group 4 element-Group 10 element. For example, the matrix may form a Si—Ti—Ni matrix. In an implementation, as will be apparent to a person of ordinary skill in the art from the foregoing description, the one element selected from the elements of Group 14 of the periodic table of the elements in the matrix may be the same element as the one element selected from the elements of Group 14 of the periodic table of the elements in the crystalline phase.

The ternary alloy of the composite anode active material may have a composition represented by Formula 1 below:

M1ₐM2_{b}M3_{c} <Formula 1>

In Formula 1, 5<a<10, 1<b<5, and 1<c<5.

M1 may be silicon (Si), germanium (Ge), or tin (Sn).

M2 and M3 may each independently be elements (e.g., metals, metalloids, or non-metals) selected from the group of scandium (Sc), titanium (Ti), vanadium (V), chromium (Cr), manganese (Mn), iron (Fe), cobalt (Co), nickel (Ni), copper (Cu), zinc (Zn), magnesium (Mg), calcium (Ca), strontium (Sr), barium (Ba), radium (Ra), yttrium (Y), zirconium (Zr), hafnium (Hf), rutherfordium (Rf), niobium (Nb), tantalum (Ta), dubnium (Db), molybdenum (Mo), tungsten (W), seaborgium (Sg), technetium (Tc), rhenium (Re), bohrium (Bh), iron (Fe), lead (Pb), ruthenum (Ru), osmium (Os), hassium (Hs), rhodium (Rh), iridium (Ir), platinum (Pt), silver (Ag), gold (Au), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), and polonium (Po).

In an implementation, the ternary alloy may have a composition represented by Formula 2 below:

M1_{d}M2ₑM3_{f} <Formula 2>

In Formula 2, 6<d<8, 3<e<5, and 3<f<5.

M1 may be silicon (Si), germanium (Ge), or tin (Sn).

M2 and M3 may each independently be elements selected from the group of scandium (Sc), titanium (Ti), vanadium (V), chromium (Cr), manganese (Mn), iron (Fe), cobalt (Co), nickel (Ni), copper (Cu), zinc (Zn), magnesium (Mg), calcium (Ca), strontium (Sr), barium (Ba), radium (Ra), yttrium (Y), zirconium (Zr), hafnium (Hf), rutherfordium (Rf), niobium (Nb), tantalum (Ta), dubnium (Db), molybdenum (Mo), tungsten (W), seaborgium (Sg), technetium (Tc), rhenium (Re), bohrium (Bh), iron (Fe), lead (Pb), ruthenum (Ru), osmium (Os), hassium (Hs), rhodium (Rh), iridium (Ir), platinum (Pt), silver (Ag), gold (Au), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), and polonium (Po).

In an implementation, the ternary alloy may have a composition represented by Formula 3 below:

Si_{d}M2ₑM3_{f} <Formula 3>

In Formula 3, 6<d<8, 3<e<5, and 3<f<5.

M2 and M3 may each independently be elements selected from the group of scandium (Sc), titanium (Ti), vanadium (V), chromium (Cr), manganese (Mn), iron (Fe), cobalt (Co), nickel (Ni), copper (Cu), zinc (Zn), magnesium (Mg), calcium (Ca), strontium (Sr), barium (Ba), radium (Ra), yttrium (Y), zirconium (Zr), hafnium (Hf), rutherfordium (Rf), niobium (Nb), tantalum (Ta), dubnium (Db), molybdenum (Mo), tungsten (W), seaborgium (Sg), technetium (Tc), rhenium (Re), bohrium (Bh), iron (Fe), lead (Pb), ruthenum (Ru), osmium (Os), hassium (Hs), rhodium (Rh), iridium (Ir), platinum (Pt), silver (Ag), gold (Au), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), and polonium (Po).

In an implementation, the ternary alloy may have a composition represented by Formula 4 below:

Si_{d}TiₑNi_{f} <Formula 4>

In Formula 4, 6<d<8, 3<e<5, and 3<f<5.

The carbonaceous coating layer in the composite anode active material may include amorphous carbon. For example, the carbonaceous coating layer may include low-crystalline carbon with a distance (d₀₀₂) between crystal planes of about 3.45 Å or greater, or amorphous carbon exhibiting no peak characteristic in XRD spectra. When the carbonaceous coating layer has high crystallinity, it may cause a side reaction with an electrolyte solution. However, low-crystalline or amorphous coating layer may not cause a side reaction with an electrolyte solution during charging and discharging, and thus may help reduce and/or prevent decomposition of the electrolyte solution and may help increase charge/discharge efficiency.

The core of the composite anode active material may have an average particle diameter (D50) of about 1 μm to about 10 μm, e.g., from about 2 μm to about 7 μm or from about 3 μm to about 5 μm. When the average particle diameter of the core is within these ranges, the composite anode active material may have further improved discharge capacity and improved lifetime characteristics. D50 indicates an average particle diameter of secondary particles.

According to another embodiment, an anode may include the above-described composite anode active material. For example, the anode may be manufactured by molding an anode active material composition (including the composite anode active material and a binder) into a desired shape, by coating the anode active material composition on a current collector such as a copper foil, or the like.

For example, the composite anode active material, a conducting agent, a binder, and a solvent may be mixed to prepare the anode active material composition. The anode active material composition may be directly coated on a metallic current collector to prepare an anode plate. Alternatively, the negative active material composition may be cast on a separate support to form a negative active material film, which may then be separated from the support and laminated on a metallic current collector to prepare a negative plate. The anode is not limited to the examples described above, and may be one of a variety of types.

In an implementation, the anode may further include another anode active material, in addition to the above-described composite anode active material.

Examples of the other anode active materials that may be further included in the anode may include silicone metal, a silicon thin film, lithium metal, a lithium alloy, a carbonaceous material, and graphite, but are not limited thereto. Any suitable other anode active material may be used.

Additional examples of the other anode active material may include tungsten oxide, molybdenum oxide, titanium oxide, lithium titanium oxide, vanadium oxide, lithium vanadium oxide; silicon (Si), SiOₓ (0<x<2), tin (Sn), SnO₂, Sn—Z, or a mixture of at least one thereof and SiO₂ (wherein Z is selected from the group of magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof); natural graphite or artificial graphite that are in amorphous, plate, flake, spherical or fibrous form; soft carbon (carbon sintered at low temperatures), hard carbon; meso-phase pitch carbides; sintered corks, and the like.

Examples of the conducting agent may include acetylene black, ketjen black, natural graphite, artificial graphite, carbon black, carbon fiber, and metal powder and metal fiber of, for example, copper, nickel, aluminum, or silver. In an implementation, at least one conducting material, e.g., polyphenylene derivatives may be used in combination. Any suitable conducting agent may be used. The above-described crystalline carbonaceous materials may be added as the conducting agent.

Examples of the binder may include a vinylidene fluoride/hexafluoropropylene copolymer, polyvinylidene fluoride (PVDF), polyacrylonitrile, polymethylmethacrylate, polytetrafluoroethylene, mixtures thereof, and a styrene butadiene rubber polymer, but are not limited thereto. Any suitable material available as a binding agent may be used.

Examples of the solvent may include N-methyl-pyrrolidone, acetone, and water. Any suitable material available as a solvent may be used.

The amounts of the composite anode active material, the conducting agent, the binder, and the solvent are not limited, and may be levels that are generally used in manufacturing a lithium battery. At least one of the conducting agent, the binder, and the solvent may not be included, according to the use and the structure of the lithium battery.

According to another embodiment, a lithium battery may include an anode including the anode active material. The lithium battery may be manufactured in the following manner.

First, an anode may be prepared according to the above-described anode manufacturing method.

Next, a cathode active material, a conducting agent, a binder, and a solvent may be mixed to prepare a cathode active material composition. The cathode active material composition may be directly coated on a metallic current collector and dried to prepare a cathode plate. Alternatively, the cathode active material composition may be cast on a separate support to form a cathode active material film, which may then be separated from the support and laminated on a metallic current collector to prepare a cathode plate.

The cathode active material may include at least one selected from the group of lithium cobalt oxide, lithium nickel cobalt manganese oxide, lithium nickel cobalt aluminum oxide, lithium iron phosphorous oxide, and lithium manganese oxide. The cathode active material is not limited to these examples, and may be any suitable cathode active material.

For example, the cathode active material may be a compound represented by one of the following formula: LiₐA_{1-b}B_{b}D₂ (where 0.90≦a≦1.8, and 0≦b≦0.5); LiₐE_{1-b}B_{b}O_{2-c}D_{c} (where 0.90≦a≦1.8, 0≦b≦0.5, and 0≦c≦0.05); LiE_{2-b}B_{b}O_{4-c}D_{c} (where 0≦b≦0.5, and 0≦c≦0.05); LiₐNi_{1-b-c}Co_{b}BₐDₐ (where 0.90≦a≦1.8, 0≦b≦0.5, 0≦c≦0.05, and 0≦α≦2); LiₐNi_{1-b-c}Co_{b}B_{c}O_{2-α}F_{α} (where 0.90≦a≦1.8, 0≦b≦0.5, 0≦c≦0.05, and 0≦α≦2); LiₐNi_{1-b-c} Co_{b}B_{c}O_{2-α}F₂ (where 0.90≦a≦1.8, 0≦b≦0.5, 0≦c≦0.05, and 0≦α≦2); LiₐNi_{1-b-c}Mn_{b}B_{c}D_{α} (where 0.90≦a≦1.8, 0≦b≦0.5, 0≦c≦0.05, and 0≦α≦2); LiₐNi_{1-b-c}Mn_{b}B_{c}O_{2-α}F_{α} (where 0.90≦a≦1.8, 0≦b≦0.5, 0≦c≦0.05, and 0≦α≦2); LiₐNi_{1-b-c}Mn_{b}B_{C}O_{2-α}F₂ (where 0.90≦a≦1.8, 0≦b≦0.5, 0≦c≦0.05, and 0≦α≦2); LiₐNi_{b}E_{c}G_{d}O₂ (where 0.90≦a≦1.8, 0≦b≦0.9, 0≦c≦0.5, and 0.001≦d≦0.1); LiₐNi_{b}Co_{c}Mn_{d}GeO₂ (where 0.90≦a≦1.8, 0≦b≦0.9, 0≦c≦0.5, 0≦d≦0.5, and 0.001≦e≦0.1); LiₐNiG_{b}O₂ (where 0.90≦a≦1.8, and 0.001≦b≦0.1); LiₐCoG_{b}O₂ (where 0.90≦a≦1.8, and 0.001≦b≦0.1); LiₐMnG_{b}O₂ (where 0.90≦a≦1.8, and 0.001≦b≦0.1); LiₐMn₂G_{b}O₄ (where 0.90≦a≦1.8, and 0.001≦b≦0.1); QO₂; QS₂; LiQS₂; V₂O₅; LiV₂O₅; LiIO₂; LiNiVO₄; Li_{(3-f)}J₂(PO₄)₃ (where 0≦f≦2); Li_{(3-f)}Fe₂(PO₄)₃ (where 0≦f≦2); and LiFePO₄:

In the formulae above, A may be selected from the group of nickel (Ni), cobalt (Co), manganese (Mn), and combinations thereof; B may be selected from the group of aluminum (Al), nickel (Ni), cobalt (Co), manganese (Mn), chromium (Cr), iron (Fe), magnesium (Mg), strontium (Sr), vanadium (V), a rare earth element, and combinations thereof; D may be selected from the group of oxygen (O), fluorine (F), sulfur (S), phosphorus (P), and combinations thereof; E may be selected from the group of cobalt (Co), manganese (Mn), and combinations thereof; F may be selected from the group of fluorine (F), sulfur (S), phosphorus (P), and combinations thereof; G may be selected from the group of aluminum (Al), chromium (Cr), manganese (Mn), iron (Fe), magnesium (Mg), lanthanum (La), cerium (Ce), strontium (Sr), vanadium (V), and combinations thereof; Q may be selected from the group of titanium (Ti), molybdenum (Mo), manganese (Mn), and combinations thereof; I may be selected from the group of chromium (Cr), vanadium (V), iron (Fe), scandium (Sc), yttrium (Y), and combinations thereof; and J may be selected from the group of vanadium (V), chromium (Cr), manganese (Mn), cobalt (Co), nickel (Ni), copper (Cu), and combinations thereof.

Compounds listed above as positive active materials may have a surface coating layer (hereinafter, “coating layer”). Alternatively, a mixture of a compound without having a coating layer and a compound having a coating layer, the compounds being selected from the compounds listed above, may be used. The coating layer may include at least one compound of a coating element selected from the group of oxide, hydroxide, oxyhydroxide, oxycarbonate, and hydroxycarbonate of the coating element. The compounds for the coating layer may be amorphous or crystalline. The coating element for the coating layer may include magnesium (Mg), aluminum (Al), cobalt (Co), potassium (K), sodium (Na), calcium (Ca), silicon (Si), titanium (Ti), vanadium (V), tin (Sn), germanium (Ge), gallium (Ga), boron (B), arsenic (As), zirconium (Zr), or mixtures thereof. The coating layer may be formed using a suitable method that does not adversely affect the physical properties of the cathode active material when a compound of the coating element is used. For example, the coating layer may be formed using a spray coating method, a dipping method, or the like.

Examples of the cathode active material may include LiNiO₂, LiCoO₂, LiMnₓO₂ₓ (x=1, 2), LiNi₁₋ₓMnₓO₂ (where 0<x<1), LiNi_{1-x-y}CoₓMn_{y}O₂ (where 0≦x≦0.5 and 0≦y≦0.5), LiFeO₂, V₂O₅, TiS, and MoS.

The conducting agent, the binder, and the solvent used for the cathode active material composition may be the same as those used for the anode active material composition. In an implementation, a plasticizer may be further added into the cathode active material composition and/or the anode active material composition to form pores in the electrode plates.

Amounts of the cathode electrode active material, the conducting agent, the binder, and the solvent may correspond with levels that are generally used to the manufacture of a lithium battery. In an implementation, at least one of the conducting agent, the binder, and the solvent may not be included according to the use and the structure of the lithium battery.

Next, a separator to be disposed between the cathode and the anode may be prepared. The separator may be a suitable separator that is commonly used for lithium batteries. The separator may have low resistance to migration of ions in an electrolyte and may have an excellent electrolyte-retaining ability. Examples of the separator may include glass fiber, polyester, Teflon, polyethylene, polypropylene, polytetrafluoroethylene (PTFE), and a combination thereof, each of which may be a non-woven or woven fabric. For example, a rollable separator including polyethylene or polypropylene may be used for a lithium ion battery. A separator with a good organic electrolyte solution-retaining ability may be used for a lithium ion polymer battery. For example, the separator may be manufactured in the following manner.

A polymer resin, a filler, and a solvent may be mixed together to prepare a separator composition. Then, the separator composition may be directly coated on an electrode, and then dried to form the separator. Alternatively, the separator composition may be cast on a support and then dried to form a separator film, which may then be separated from the support and laminated on an electrode to form the separator.

The polymer resin used to manufacture the separator may be a suitbale material that is commonly used as a binder for electrode plates. Examples of the polymer resin may include a vinylidenefluoride/hexafluoropropylene copolymer, polyvinylidene fluoride (PVDF), polyacrylonitrile, polymethylmethacrylate and a mixture thereof.

Next, an electrolyte may be prepared. For example, the electrolyte may be an organic electrolyte solution. Alternately, the electrolyte may be in a solid phase. Non-limiting examples of the electrolyte may include lithium oxide and lithium oxynitride. Any suitable material available as a solid electrolyte in the art may be used. The solid electrolyte may be formed on the anode by, e.g., sputtering.

In an implementation, an organic electrolyte solution may be prepared as follows. The organic electrolyte solution may be prepared by dissolving a lithium salt in an organic solvent.

The organic solvent may include a suitable solvent available as an organic solvent in the art. Examples of the organic solvent may include propylene carbonate, ethylene carbonate, fluoroethylene carbonate, butylene carbonate, dimethyl carbonate, diethyl carbonate, methylethyl carbonate, methylpropyl carbonate, ethylpropyl carbonate, methylisopropyl carbonate, dipropyl carbonate, dibutyl carbonate, benzonitrile, acetonitrile, tetrahydrofuran, 2-methyltetrahydrofuran, γ-butyrolactone, dioxorane, 4-methyldioxorane, N,N-dimethyl formamide, dimethyl acetamide, dimethylsulfoxide, dioxane, 1,2-dimethoxyethane, sulforane, dichloroethane, chlorobenzene, nitrobenzene, diethylene glycol, dimethyl ether, and mixtures thereof.

The lithium salt may include a suitable material available as a lithium salt in the art. Non-limiting examples of the lithium salt are LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, LiI, or a mixture thereof.

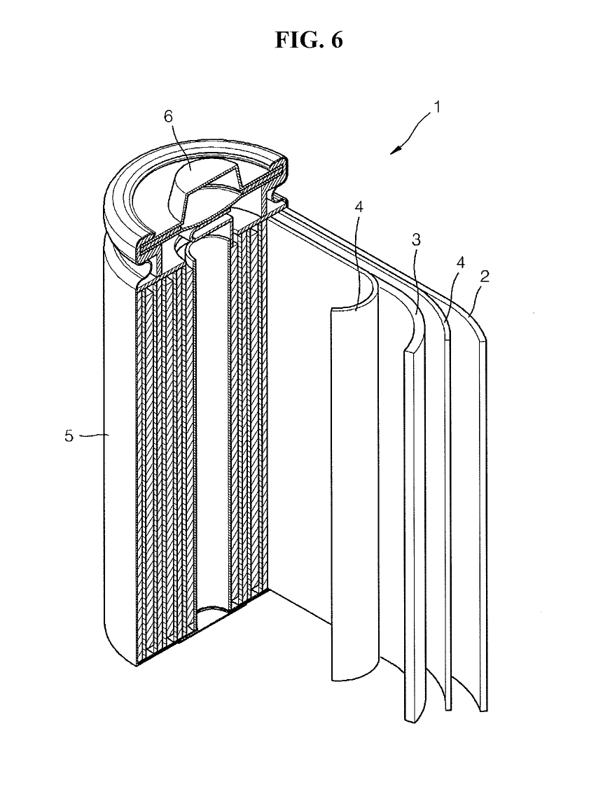

FIG. 6 illustrates a schematic view of a lithium battery according to an embodiment. Referring to FIG. 6, a lithium battery 1 may include a cathode 3, an anode 2, and a separator 4. The cathode 3, the anode 2, and the separator 4 are wound or folded, and then sealed in a battery case 5. Then, the battery case 5 may be filled with an, e.g., organic, electrolyte solution and sealed with a cap assembly 6, thereby completing the manufacture of the lithium battery 1. The battery case 5 may be a cylindrical type, a rectangular type, or a thin-film type. For example, the lithium battery may be a thin-film type battery. The lithium battery may be a lithium ion battery.

The separator 4 may be interposed between the cathode 3 and the anode 2 to form a battery or electrode assembly. Alternatively, the battery or electrode assembly may be stacked in a bi-cell structure and impregnated with the electrolyte solution. The resultant may be put into a pouch and hermetically sealed, thereby completing the manufacture of a lithium ion polymer battery.

Alternatively, a plurality of battery or electrode assemblies may be stacked to form a battery pack, which may be used in any device that operates at high temperatures and requires high output, e.g., in a laptop computer, a smart phone, electric vehicle, and the like.

The lithium battery may have improved high rate characteristics and lifetime characteristics, and thus may be applicable in an electric vehicle (EV), e.g., in a hybrid vehicle such as plug-in hybrid electric vehicle (PHEV).

According to another embodiment, a method of preparing a composite anode active material may include preparing a solution including a ternary alloy and a carbon precursor; drying the solution to obtain a dried product; and calcining the dried product.

In an implementation, the calcining may be performed at a temperature of less than about 600° C. When the calcining is performed at low temperature, e.g., less than about 600° C., the crystallites in the ternary alloy may maintain a same size as a size before the thermal treatment. Thus, deterioration in physical characteristics of the alloy (that may otherwise occur from thermal treatment at high temperatures of about 600° C. or greater) may be prevented.

For example, the calcining may be performed at less than about 600° C., at which the carbon precursor starts to carbonize. In an implementation, the calcining may be performed at a temperature of about 300° C. to less than about 600° C., e.g., from about 400° C. to less than about 600° C., from about 350° C. to about 550° C., from about 450° C. to about 550° C., or from about 370° C. to about 530° C.

The calcining may be performed under an inert atmosphere, e.g., a nitrogen or argon atmosphere. In an implementation, the calcining may be performed under another suitable inert atmosphere.

In the method of preparing a composite anode active material, the carbon precursor may be a non-ionic surfactant. Non-ionic surfactants may include no charge in molecules, unlike cationic or anionic surfactants, and thus may have low molecular polarity. Accordingly, non-ionic surfactants may be coated easily on ternary alloys with weak surface polarity.

For example, the non-ionic surfactant may include at least one selected from among polyoxyethylene glycol alkyl ethers, such as CH₃₋(CH₂)_{10˜16}-(O—C₂H₄)_{1˜25}—OH, octaethylene glycol monododecyl ether, and pentaethylene glycol monododecyl ether; polyoxypropylene glycol alkyl ethers, such as CH₃—(CH₂)_{10˜16}-(O—C₃H₆)_{1˜25}—OH); glucoside alkyl ethers, such as CH₃—(CH₂)_{10˜16}-(O-glucoside)_{1˜3}—OH, decyl glucoside, lauryl glucoside, and octyl glucoside; polyoxyethylene glycol octylphenol ethers, such as C₈₁H₁₇—(C₆H₄)—(O—C₂H₄)_{1˜25}—OH and Triton X-100; polyoxyethylene glycol alkylphenol ethers, such as C₉H₁₉—(C₆H₄)—(O—C₂H₄)_{1˜25}—OH and nonoxynol-9; glycerol alkyl esters, such as glyceryl laurate, glyceryl mirystate, glyceryl palmitate, and glyceryl stearate; polyoxyethylene glycol sorbitan alkyl esters, such as polysorbate; sorbitan alkyl esters, such as polysorbate20, polysorbate40, polysorbate 60, and polysorbate 80; dodecyldimethylamine oxide; diethanolamides, such as cocamide monoethanolamine (MEA) and cocamide diethanolamine (DEA); block copolymers of polyethylene glycol and polypropylene glycol, such as poloxamer; and polyethoxylated tallow amine (POEA), but is not limited thereto. Any of a variety of suitable non-ionic surfactants may be used.

In an implementation, the non-ionic surfactant may include Triton X-100 represented by Formula 5 below:

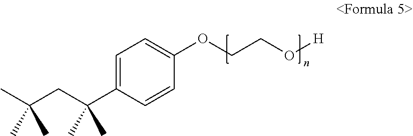

In Formula 5, n may be from 8 to 10.

In an implementation, the non-ionic surfactant may include Nonoxynol-9 represented by Formula 6 below:

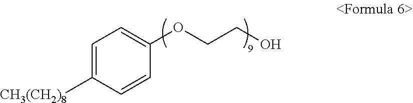

In an implementation, the non-ionic surfactant may include Span 20 (Polysorbate 20) represented by Formula 7 below:

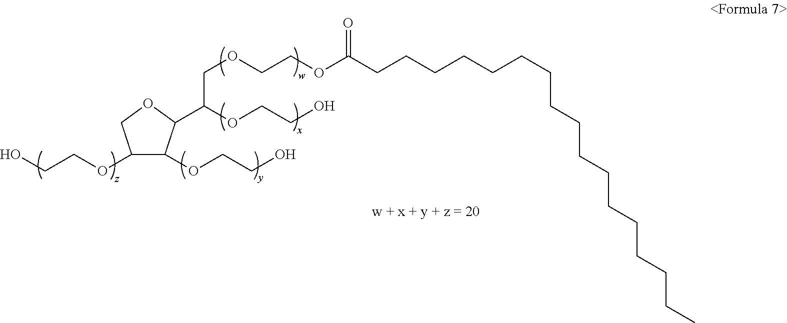

To be carbonized at a temperature less than about 600° C. or less, the non-ionic surfactant may have a molecular structure having a low molecular weight or prone to carbonization.

In the method of preparing the composite anode active material, the ternary alloy may be in the form of particles having an average particle diameter (D50) of from about 1 μm to about 10 μm, e.g., from about 2 μm to about 7 μm or from about 3 μm to about 5 μm. When the average particle diameter of the ternary alloy is within these ranges, a lithium battery with improved discharge capacity and improved lifetime characteristics may be manufactured using the composite anode active material.

In the method of preparing the composite anode active material, the ternary alloy may have a composition represented by Formula 1 below:

M1ₐM2_{b}M3_{c} <Formula 1>

In Formula 1, 5<a<10, 1<b<5, and 1<c<5.

M1 may be Si, Ge, or Sn.

M2 and M3 may each independently be elements selected from the group of scandium (Sc), titanium (Ti), vanadium (V), chromium (Cr), manganese (Mn), iron (Fe), cobalt (Co), nickel (Ni), copper (Cu), zinc (Zn), magnesium (Mg), calcium (Ca), strontium (Sr), barium (Ba), radium (Ra), yttrium (Y), zirconium (Zr), hafnium (Hf), rutherfordium (Rf), niobium (Nb), tantalum (Ta), dubnium (Db), molybdenum (Mo), tungsten (W), seaborgium (Sg), technetium (Tc), rhenium (Re), bohrium (Bh), iron (Fe), lead (Pb), ruthenum (Ru), osmium (Os), hassium (Hs), rhodium (Rh), iridium (Ir), platinum (Pt), silver (Ag), gold (Au), cadmium (Cd), boron (B), aluminum (Al), gallium (Ga), tin (Sn), indium (In), germanium (Ge), phosphorus (P), arsenic (As), antimony (Sb), bismuth (Bi), sulfur (S), selenium (Se), tellurium (Te), and polonium (Po).

The following Examples, Comparative Examples, and Reference Examples are provided in order to highlight characteristics of one or more embodiments, but it will be understood that the Examples, Comparative Examples, and Reference Examples are not to be construed as limiting the scope of the embodiments, nor are the Comparative or Reference Examples to be construed as being outside the scope of the embodiments. Further, it will be understood that the embodiments are not limited to the particular details described in the Examples, Comparative Examples, and Reference Examples.

### Preparation of Composite Anode Active Material

### Example 1

4 g of Triton X-100 (Sigma-Aldrich, Lot#031M0301V) was added to 130 g of distilled water, and then stirred at about 50° C. for about 24 hours to prepare a dispersion. 20 g of ternary alloy powder of Si₇Ti₄Ni₄ having an average particle diameter (D50) of about 3 μm was added into the dispersion, and then stirred at about 25° C. for about 24 hours to obtain a mixed solution, which was dried with stirring at about 120° C. for about 3 hours, and then under a nitrogen atmosphere at about 200° C. for about 6 hours to obtain a dried product. The dried product was calcined under a nitrogen atmosphere at about 500° C. to obtain a composite anode active material with a carbonaceous coating layer on a ternary alloy core. FIG. 1 illustrates a scanning electron microscopic (SEM) image of the ternary alloy.

### Example 2

A composite anode active material was prepared in the same manner as in Example 1, except that the calcination temperature of the dried product was performed at about 550° C.

### Comparative Example 1

Ternary alloy powder of Si₇Ti₄Ni₄ having an average particle diameter (D50) of about 3 μm was used as anode active material.

### Reference Example 1

A composite anode active material was prepared in the same manner as in Example 1, except that the calcination temperature of the dried product was about 700° C.

### Reference Example 2

A composite anode active material was prepared in the same manner as in Example 1, except that the calcination temperature of the dried product was about 800° C.

### Manufacture of Anode and Lithium Battery

### Example 3

The composite anode active material powder synthesized in Example 1, Ketjen Black as a conducting agent, and polyamide-imide (PAI) as a binder were mixed in distilled water in a weight ratio of about 90:8:2 to prepare a slurry, which was coated on a 10 μm-thick Cu foil and then dried at about 110° C. for about 15 minutes to form an anode plate, which was further dried to manufacture a coin cell (CR2016) having a diameter of about 20 mm.

To manufacture a cathode plate, Li[Ni_{0.56}CO_{0.22}Mn_{0.22}]O₂ (NCM) powder having an average particle diameter of about 15 μm (available from Samsung SDI) and Denka Black were uniformly mixed in a weight ratio of 92:4, and then with polyvinylidene fluoride (PVDF) solution as a binder in a weight ratio of 92:4:4 to prepare a cathode active material slurry, which was then coated on a surface of a 15 μm-thick Al current collector to a thickness of about 55 μm by using an applicator, and then dried at about 120° C. for about 3 hours, thereby manufacturing a (NCM) cathode plate.

In manufacturing a coin cell, the NCM cathode plate as a counter electrode, a polyethylene separator (Star® 20) having a thickness of about 20 μm, and an electrolyte solution of 1.15M LiPF₆ dissolved in a mixed solvent of ethylenecarbonate (EC), diethylcarbonate (DEC), and fluoroethylene carbonate (FEC) in a 5:70:25 volume ratio were used.

### Example 4

A lithium battery was manufactured in the same manner as in Example 3, except that the composite anode active material of Example 2 was used.

### Comparative Example 2

A lithium battery was manufactured in the same manner as in Example 3, except that the composite anode active material of Comparative Example 1 was used.

### Reference Examples 3-4

Lithium batteries were manufactured in the same manner as in Example 3, except that the composite anode active materials of Reference Examples 1 and 2 were respectively used.

### Evaluation Example 1

### X-Ray Diffraction (XRD) Test

XRD test of the composite anode active material powders of Examples 1 to 2,

Comparative Example 1, and Reference Examples 1 and 2 was conducted. Some of the results are shown in Table 1 below. The XRD test was conducted at a CuK-α X-ray wavelength of 1.541 Å.

TABLE 1

| | Diffraction angle | FWHM | Size of Si |
|---|---|---|---|
| | of Si [111] peak | of Si [111] peak | crystallite |
| Example | [2θ degree] | [degree] | [nm] |
| Example 1 | 28.500 | 0.2491 | 32.9 |
| Comparative | 28.536 | 0.2591 | 31.6 |
| Example 1 | | | |
| Reference | 28.542 | 0.2406 | 34.1 |
| Example 1 | | | |
| Reference | 28.478 | 0.2124 | 38.6 |
| Example 2 | | | |

Referring to Table 1, the composite anode active material of Example 1 had smaller Si crystalites than those of the composite anode active materials of Reference Examples 1 and 2, which were calcined at higher temperatures. The composite anode active particles of Example 1 had a full width at half maximum (FWHM) of about 0.245° or greater.

### Evaluation Example 2

### Evaluation of Charge-Discharge Characteristics

The coin cells of Examples 3 and 4, Comparative Example 2, and Reference Examples 3 and 4 were each charged with a constant current of 0.1 C rate at about 25° C. until the voltage of the cell reached about 4.25V, and then at a constant voltage of about 4.25V until the current reached 0.01 C. Afterward, the cell was discharged at a constant current of 0.1 C until the voltage reached 2.75V.

Subsequently, the cell was charged with a constant current of 0.2 C rate until the voltage of the cell reached about 4.25V, and then at a constant voltage of about 4.25V until the current reached 0.01 C. Afterward, the cell was discharged with a constant current of 0.2 C until the voltage reached 2.75V (Formation process).

Subsequently, each of the lithium batteries after the formation process was charged with a constant current of 1.0 C rate at about 25° C. until the voltage of the cell reached about 4.25V, and then at a constant voltage of about 4.23V until the current reached 0.01 C, followed by discharging with a constant current of about 1.0 C until the voltage reached about 2.75V. This cycle of charging and discharging was repeated 50 times.

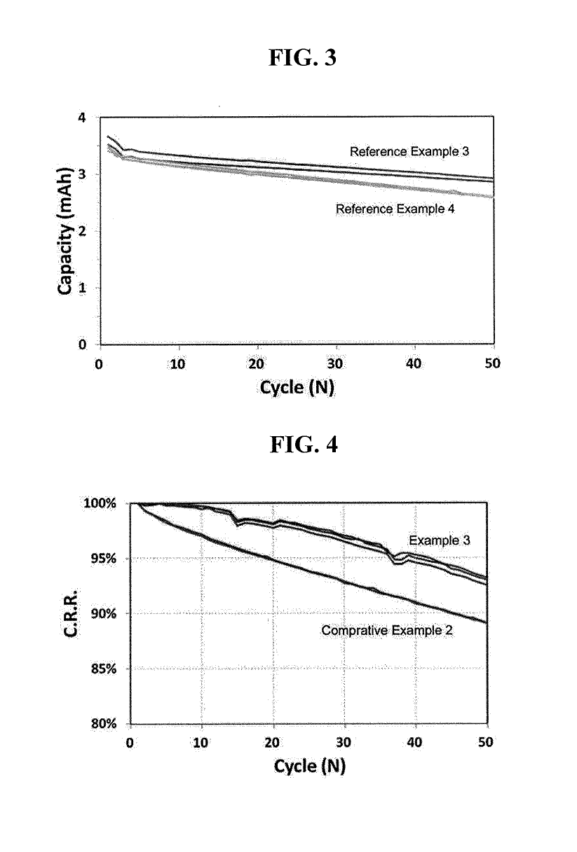

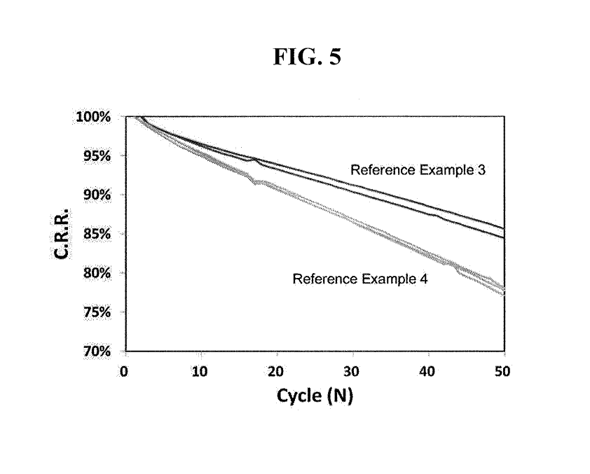

Some of the charging/discharging test results are shown in Table 2 and FIGS. 2 to 5. Charge/discharge efficiency and capacity retention rate may be represented by Equations 1 and 2, respectively:

Charge/discharge efficiency at 1^{St} cycle [%]=[Discharge capacity at 1^{st} cycle/Charge capacity at 1^{st} cycle]×100 ≦Equation 1>

Capacity retention rate [%]=[Discharge capacity at 50^{th} cycle/Discharge capacity at 1^{st} cycle]×100 ≦Equation 2>

TABLE 2

| | Charge/discharge | Capacity retention | Discharge |
|---|---|---|---|
| | efficiency at 1st | rate at 50th | capacity at 50th |
| Example | cycle [%] | cycle [%] | cycle [mAh] |
| Example 3 | 76.0 | 92.9 | 3.09 |
| Comparative | 66.8 | 89.1 | 2.72 |
| Example 2 | | | |
| Reference | 74.1 | 85.0 | 2.86 |
| Example 3 | | | |
| Reference | 75.1 | 77.7 | 2.55 |
| Example 4 | | | |

Referring to Table 2 and FIGS. 2 to 5, the lithium batteries of Example 3 exhibited improved initial efficiencies, improved lifetime characteristics, and improved discharge capacities, as compared with the lithium batteries of Comparative Example 2 and Reference Examples 3 and 4. As described above, according to the one or more of the above embodiments, a lithium battery with improved discharge capacity and improved lifetime characteristics may be manufactured using a composite anode active material with a carbonaceous coating layer on a core including a ternary alloy.

By way of summation and review, carbonaceous materials may be porous and stable with little volumetric change during charging and discharging. However, carbonaceous materials may lead to a low-battery capacity due to the porous structure of carbon. For example, graphite, which is an ultra-high crystalline material, has a theoretical capacity density of about 372 mAh/g in the form of LiC₆, and low high-rate properties.

Metals or elements that are alloyable with lithium may be used as an anode active material with a higher electrical capacity, as compared with carbonaceous materials. Examples of metals or elements that are alloyable with lithium may include silicon (Si), tin (Sn), aluminum (Al), or the like. These metals or elements alloyable with lithium may have low charge/discharge efficiency, may be apt to deteriorate, and may have relatively poor lifetime characteristics. For example, with repeated charging and discharging operations, repeated agglomeration and breakage of Sn particles may occur, leading to undesirable electric shorts.

Against such background, the embodiments provide a composite anode active material, an anode including the composite anode active material, a lithium battery including the anode, and a method of preparing the composite anode active material, lithium battery with improved discharge capacity and improved lifetime characteristics.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A composite anode active material, comprising:
a core including a ternary alloy, the ternary alloy being capable of intercalating and deintercalating lithium; and
a carbonaceous coating layer on the core.

2. The composite anode active material as claimed in claim 1, wherein the ternary alloy comprises:
a matrix inert to lithium; and
a crystalline phase dispersed in the matrix, the crystalline phase being capable of intercalating and deintercalating lithium.

3. The composite anode active material as claimed in claim 2, wherein the crystalline phase comprises at least one element selected from the elements of Group 14 of the periodic table of the elements.

4. The composite anode active material as claimed in claim 2, wherein the crystalline phase comprises at least one element selected from the group of silicon, germanium, and tin.

5. The composite anode active material as claimed in claim 2, wherein the crystalline phase comprises silicon.

6. The composite anode active material as claimed in claim 2, wherein the crystalline phase comprises nano-sized crystallite.

7. The composite anode active material as claimed in claim 6, wherein the crystallite has a size of about 33.5 nm or less.

8. The composite anode active material as claimed in claim 6, wherein the crystallite has a size of about 30 nm to about 33 nm.

9. The composite anode active material as claimed in claim 2, wherein the crystalline phase exhibits a peak with a full width at half maximum (FWHM) of about 0.245° or greater at a diffraction angle (2θ) of 28.50°±0.10° in X-ray diffraction spectra.

10. The composite anode active material as claimed in claim 9, wherein the FWHM is in a range of 0.245°≦FWHM≦0.265°.

11. The composite anode active material as claimed in claim 2, wherein the matrix comprises one element selected from the elements of Group 14 of the periodic table of the elements, and two elements selected from transition metals of Group 3 to Group 12 of the periodic table of the elements.

12. The composite anode active material as claimed in claim 1, wherein the ternary alloy has a composition represented by Formula 1 below:
M1ₐM2_{b}M3_{c} <Formula 1>
wherein, in Formula 1, 5<a<10, 1<b<5, and 1<c<5,
M1 is silicon, germanium, or tin, and
M2 and M3 are each independently an element selected from the group of scandium, titanium, vanadium, chromium, manganese, iron, cobalt, nickel, copper, zinc, magnesium, calcium, strontium, barium, radium, yttrium, zirconium, hafnium, rutherfordium, niobium, tantalum, dubnium, molybdenum, tungsten, seaborgium, technetium, rhenium, bohrium, iron, lead, ruthenum, osmium, hassium, rhodium, iridium, platinum, silver, gold, cadmium, boron, aluminum, gallium, tin, indium, germanium, phosphorus, arsenic, antimony, bismuth, sulfur, selenium, tellurium, and polonium.

13. The composite anode active material as claimed in claim 1, wherein the carbonaceous coating layer comprises amorphous carbon.

14. The composite anode active material as claimed in claim 1, wherein the core has a D50 average particle diameter of about 1 μm to about 10 μm.

15. An anode comprising the composite anode active material as claimed in claim 1.

16. A lithium battery comprising the anode as claimed in claim 15.

17. A method of preparing a composite anode active material, the method comprising:
preparing a solution that includes a ternary alloy and a carbon precursor;
drying the solution to obtain a dried product; and
calcining the dried product.

18. The method as claimed in claim 17, wherein the calcining is performed at a temperature of less than about 600° C.

19. The method as claimed in claim 17, wherein the calcining is performed under an inert atmosphere.

20. The method as claimed in claim 17, wherein the carbon precursor comprises a nonionic surfactant.

21. The method as claimed in claim 17, wherein the carbon precursor comprises at least one selected from the group of polyoxyethylene glycol alkyl ethers, polyoxypropylene glycol alkyl ethers, glucoside alkyl ethers, polyoxyethylene glycol octylphenol ethers, polyoxyethylene glycol alkylphenol ethers, glycerol alkyl esters, polyoxyethylene glycol sorbitan alkyl esters, sorbitan alkyl esters, dodecyldimethylamine oxide, ethanol amide, block copolymers of polyethylene glycol and polypropylene glycol, and polyethoxylated tallow amine.

22. The method as claimed in claim 17, wherein the ternary alloy has an average particle diameter from about 1 μm to about 10 μm.

23. The method as claimed in claim 17, wherein the ternary alloy has a composition represented by Formula 1 below:
M1ₐM2_{b}M3_{c} <Formula 1>
wherein, in Formula 1, 5<a<10, 1<b<5, and 1<c<5,
M1 is silicon, germanium, or tin, and
M2 and M3 are each independently an element selected from the group of scandium, titanium, vanadium, chromium, manganese, iron, cobalt, nickel, copper, zinc, magnesium, calcium, strontium, barium, radium, yttrium, zirconium, hafnium, rutherfordium, niobium, tantalum, dubnium, molybdenum, tungsten, seaborgium, technetium, rhenium, bohrium, iron, lead, ruthenum, osmium, hassium, rhodium, iridium, platinum, silver, gold, cadmium, boron, aluminum, gallium, tin, indium, germanium, phosphorus, arsenic, antimony, bismuth, sulfur, selenium, tellurium, and polonium.
